(19) United States
(12) Patent Application Publication
(10) Pub. No.: US 2026/0045375 A1
(43) Pub. Date: Feb. 12, 2026

(54) LOCALISED ENERGY CONCENTRATION

(71) Applicant: FIRST LIGHT FUSION LIMITED, Yarnton, Oxfordshire (GB)

(72) Inventors: Peter Allan, Yarnton, Oxfordshire (GB); Matthew Betney, Yarnton, Oxfordshire (GB); Hugo Doyle, Yarnton, Oxfordshire (GB); Mila Fitzgerald, Yarnton, Oxfordshire (GB); Nicholas Hawker, Yarnton, Oxfordshire (GB); Nathan Joiner, Yarnton, Oxfordshire (GB); Nicolas Niasse, Yarnton, Oxfordshire (GB); James Pecover, Yarnton, Oxfordshire (GB); Timothy Ringrose, Yarnton, Oxfordshire (GB); Jonathan Skidmore, Yarnton, Oxfordshire (GB)

(21) Appl. No.: 19/099,678

(22) PCT Filed: Jul. 27, 2023
(86) PCT No.: PCT/GB2023/051996

§ 371 Date: Jan. 29, 2025

(30) Foreign Application Priority Data
Aug. 5, 2022 (GB) 2211488.8

(51) Int. Cl. G21B 3/00

(52) U.S. Cl. CPC G21B 3/008

(57) ABSTRACT

A system for producing a localised concentration of energy from an input shockwave includes an amplifier arranged to manipulate one or more of the speed, pressure or shape of an input shockwave. The amplifier comprises a body of a first material, the body defining a cavity for manipulating the input shockwave to produce a manipulated shockwave. The cavity comprises an input for receiving the input shockwave incident upon the amplifier; and an output for outputting a manipulated shock-wave. The system further comprises a target configured to contain fuel, with the amplifier and the target being configured such that the manipulated shockwave is arranged to be output from the amplifier to be incident on the target.

### CROSS-REFERENCE TO RELATED APPLICATIONS

This application is a 35 U.S. C. § 371 national phase filing of International Application No. PCT/GB2023/051996 filed on Jul. 27, 2023, and claims the benefit of United Kingdom Patent Application No. 2211488.8 filed on Aug. 5, 2022, wherein the entire disclosures of the foregoing applications are hereby incorporated by reference herein.

### TECHNICAL FIELD

This invention relates to methods and apparatuses for producing high localised concentrations of energy.

### BACKGROUND

It has been shown in WO 2011/138622 that an interaction between a shockwave in a non-gaseous medium and a gaseous medium can generate a high speed transverse jet of the non-gaseous medium that moves through the gaseous medium. This results in the jet impacting on and trapping a volume of the gaseous medium, e.g. against a target, which gives rise to an intense concentration of energy within the gas.

The present invention aims to provide alternative techniques for producing localised energy concentrations.

### SUMMARY

When viewed from a first aspect, the invention provides a system for producing a localised concentration of energy comprising:
an amplifier arranged to manipulate one or more of the speed, pressure or shape of an input shockwave, wherein the amplifier comprises:
   a body comprising a first material;
      wherein the body defines a cavity for manipulating the input shockwave so to produce a manipulated shockwave;
         wherein the cavity comprises: an input for receiving the input shockwave incident upon the amplifier; and an output for outputting a manipulated shockwave
wherein the system further comprises a target configured to contain fuel; and
wherein the amplifier and the target are configured such that the manipulated shockwave is arranged to be output from the amplifier so to be incident upon the target.

The invention thus provides a system comprising an amplifier that manipulates a shockwave when the shockwave is incident on the amplifier and a target which contains fuel such that the fuel is shocked by the manipulated shockwave which is output from the amplifier. The amplifier has an input (e.g. aperture) for receiving the input shockwave and an output (e.g. aperture) for outputting a manipulated shockwave. The cavity is designed (e.g. shaped) to manipulate the shockwave as it passes through the cavity.

Thus it will be seen that by providing a system having an amplifier configured to manipulate an input shockwave, which is provided separately from a target, the shockwave can be manipulated to provide higher pressures at the target. Further, the modular (e.g. separate amplifier and target) nature of the system allows different target designs to be used with different amplifier designs. This increases the configurability of the system, which may be especially useful during experimentation.

The body of the amplifier, which is made from a first material, defines the cavity within the body. The cavity, e.g. a volume defined by and within the body, is thus preferably surrounded by the body (e.g. other than the input and the output).

In embodiments, the cavity contains a second material having a shock-impedance that is lower than a shock-impedance of the first material. Preferably the second material is between the input and the output of the cavity. Thus, the body preferably comprises a material having a higher shock-impedance than the (second) material of, or contained in, (e.g. at least some of) the cavity.

In embodiments, the amplifier (and thus the cavity) is shaped such that the input has a cross sectional area that is greater than the (e.g. corresponding) cross sectional area of the output. The cross sectional area of the input and/or the output may be defined in a plane substantially perpendicular to a direction between the input and the output, e.g. such that the cross sectional area of the input is substantially parallel to the cross sectional area of the output, e.g. the (plane of the) input aperture is substantially parallel to the (plane of the) output aperture. The direction between the input and the output may be substantially parallel to the direction in which, in embodiments of the invention, the input shockwave is arranged to be propagated to be incident upon the amplifier.

In embodiments, the amplifier (and thus the cavity) may be shaped such that the cross sectional area of the cavity in a plane substantially perpendicular to the direction between the input and the output may decrease linearly or non-linearly. In embodiments, the cross sectional area of the cavity may initially increase when moving from the input towards the output, and then decrease. In embodiments, the cross sectional area of the output may be greater than the cross sectional area of the input (e.g. the cavity may have a flared output). Thus, for example, the cross sectional area of the cavity may initially decrease when moving from the input towards the output, and then increase.

In embodiments, a minimum distance between (e.g. the smallest distance between two points on (the respective apertures of)) the input and the output is greater than a maximum dimension (e.g. the largest distance from one point on the perimeter to another point on the perimeter, e.g. the diameter) of the output.

In embodiments, a minimum distance between (e.g. the smallest distance between two points on (the respective apertures of)) the input and the output is greater than a maximum dimension (e.g. the largest distance from one point on the perimeter to another point on the perimeter, e.g. the diameter) of the input.

The body may have any suitable and desired dimensions, e.g. to be determined by the specific application of the amplifier. In one embodiment the (e.g. cavity of the) body has a thickness, diameter and/or maximum dimension between 0.1 mm and 100 mm, e.g. between 1 mm and 50 mm, e.g. between 2 mm and 10 mm, e.g. approximately 3 mm, 5 mm or 8 mm.

In embodiments, the body is formed from (comprises, e.g. consists of) a first material and the cavity contains (e.g. is at least partially filled with) a second material. In such embodiments, the second material has a shock-impedance that is lower than a shock-impedance of the first material. Thus the (shape of the) cavity is defined by the (e.g. internal walls of the) body (formed from the first material) and the second material is located within the volume of the cavity.

Thus it will be seen that, in embodiments, the amplifier can be used to manipulate (e.g. modify the shape and/or intensity of) an input shockwave, owing to the (e.g. shape of the) cavity and the difference in shock-impedance of the first and second materials. As such, the shockwave transmitted from the output of the cavity may have a greater (e.g. energy) intensity than the input shockwave received at the input of the cavity.

The body may comprise (e.g. (internal) walls having) any suitable and desired shape to define the cavity. Preferably the body has dimensions (e.g. lateral dimensions, in directions substantially perpendicular to the direction between the input and the output) that are (e.g. substantially, e.g. significantly) greater than the (e.g. lateral) dimensions of the cavity. Thus, preferably, the walls of the body are thicker than one or more (e.g. all) of the dimensions (e.g. than the width (e.g. diameter) of the input, e.g. than the width (e.g. diameter) of the output, e.g. than the maximum dimension) of the cavity. This helps to control the boundary conditions of the shockwave as it passes through the cavity.

In embodiments, the (e.g. a section of the) cavity comprises a frustum, e.g. the body is shaped to define a frustum-shaped cavity. Thus preferably a cross section of the cavity (e.g. in a plane parallel to the direction between the input and the output) comprises straight sides (walls) and, e.g., the cross section is symmetrical (in that plane).

The frustum may comprise any suitable and desired type of frustum. In embodiments, the cavity comprises a conic frustum. Thus preferably the cavity is rotationally symmetric about an axis through the cavity. Preferably the axis of the body or cavity is parallel to the direction between the input and the output.

In embodiments, the (cross section and/or walls of the) cavity comprises two or more sections that are at different respective angles to the axis of the cavity (e.g. the axis about which the cavity is rotationally symmetric, e.g. parallel to the direction between the input and the output). Thus, for example, the cavity may comprise two or more frustums (e.g. with the output of one frustum coinciding with the input of the other frustum, for each pair of successive frustums), wherein the two or more frustums have side walls having different respective angles to the axis of the cavity. Providing different angles for the sections of the cavity may help to manipulate the input shockwave in a particular manner, e.g. to accelerate the input shockwave from the input to the output.

In embodiments in which the cavity has three or more frustum sections, each section may be at a different angle to each of the other sections; however, two or more of the sections may be at the same angle, with one or more intermediate sections of the cavity at a different angle.

In embodiments, instead of or in addition to the cavity having one or more straight-sided sections (in cross section), the cavity may have a cross section having one or more sections having curved walls. For example, the cavity may comprise a flared (e.g. conic) frustum wherein the cavity walls are (e.g. elliptically) curved. These types of shapes may help to provide greater uniformity of the shock front, and the shock shape, at the output.

In embodiments, the amplifier comprises one or more impedance matching layers. Impedance matching layers help to couple energy between different layers of material. The Impedance matching layer may comprise a (intermediate) layer of material provided between two other materials, wherein the impedance matching layer is formed from a material which has a shock-impedance that is between the shock-impedance of the two materials.

For example, a layer of copper may be provided between layers of aluminium and tantalum. In embodiments, impedance matching layers may comprise a plurality of materials which are arranged in (e.g. parallel) layers such that the shock-impedance changes (e.g. incrementally) between layers.

In embodiments, the amplifier comprises an input impedance matching layer adjacent to (e.g. extending across) the (e.g. aperture of the) input of the cavity. The input impedance matching layer helps to improve the transmittal of energy (e.g. from an incident projectile) into the second material, by helping to reduce the reflected element of the input shockwave, e.g. from the surface of the second material. Thus the input impedance matching layer may help to couple the input shockwave into the cavity.

In embodiments, the input impedance matching layer comprises a planar layer. The input Impedance matching layer may comprise (e.g. consists of) a material having a shock-impedance that is greater than the shock-impedance of the second material, e.g. having a shock-impedance that is less than the first material, e.g. having a shock-impedance between the shock-impedance of the first material and the shock-impedance of the second material.

In embodiments, the shock-impedance of the input impedance matching layer is between the shock-impedance of (the material of) an impacting projectile configured to generate the input shockwave (e.g. when impacting on the amplifier) and the material of the second material.

In embodiments, the amplifier comprises an output impedance matching layer adjacent to (e.g. extending across) the (e.g. aperture of the) output of the cavity. The output impedance matching layer helps to improve the transmittal of energy from the (e.g. second material of the) cavity, by helping to reduce the reflected element of the shockwave as the shockwave is output from the cavity, e.g. from the output surface of the second material. Thus the output impedance matching layer may help to couple the shockwave out of the cavity.

In embodiments, the output impedance matching layer comprises a planar layer. The output impedance matching layer may comprise (e.g. consists of) a material having a shock-impedance that is less than the shock-impedance of the second material, e.g. having a shock-impedance that is greater than a (e.g. fuel or target) material upon which the output shockwave is to be incident, e.g. having a shock-impedance between the shock-impedance of the second material and the shock-impedance of a (e.g. fuel or target) material upon which the output shockwave is to be incident. In embodiments, the output impedance layer comprises polymethylpentene, e.g. TPX (RTM).

In embodiments, the cavity is partially filled with the second material, i.e. the second material does not (fully) fill the cavity. Thus, in embodiments, the cavity comprises a spacing between the input of the cavity and (an input surface of) the second material. Depending on the size and/or shape of an incident projectile, which may be used to generate the input shockwave, providing a gap in the cavity between the input (e.g. aperture) and the second material may allow the projectile to impact the (e.g. walls of the cavity of the) body of the amplifier directly, e.g. before impacting the second material. This may generate a lateral shockwave inside the projectile that may then be transferred into the cavity.

The lateral shockwave inside the projectile may help to provide transverse focussing within the projectile. This in turn has the effect that the shockwave which is transferred into the cavity is focussed more towards the central axis of the cavity.

This is considered to be novel and inventive in its own right and thus, when viewed from a further aspect, the invention provides a system for producing a localised concentration of energy comprising:
an amplifier for manipulating an input shockwave, wherein the amplifier comprises:
a body comprising a first material;
   wherein the body defines a cavity for manipulating the input shockwave so to produce a manipulated shockwave;
      wherein the cavity comprises:
         an input for receiving the input shockwave incident upon the amplifier; and
         an output for outputting the manipulated shockwave from the cavity;
      wherein the cavity contains a second material having a shock-impedance that is lower than a shock-impedance of the first material; and
   wherein the cavity comprises a spacing between the input of the cavity and an input surface of the second material;
wherein the system further comprises a target configured to contain fuel; and
wherein the amplifier and the target are configured such that the manipulated shockwave is arranged to be output from the amplifier so to be incident upon the target.

It will be appreciated that this aspect may (and preferably does) include one or more (e.g. all) of the preferred and optional features disclosed herein, e.g. relating to other aspects and embodiments of the invention, as applicable.

The spacing between the input of the cavity and the (input surface of) the second material may be filled with any suitable and desired material. In one embodiment the spacing comprises a vacuum. In one embodiment the spacing is filled with a gas. The gas may comprise any suitable and desired gas.

In embodiments, the cavity contains a plurality of (e.g. parallel) layers, wherein one or more of the plurality of layers comprises (e.g. consists of) the second material. Preferably the layers are parallel to the input and/or output (e.g. apertures) of the cavity, e.g. perpendicular to the direction between the input and the output. Thus the layers are preferably perpendicular to the direction along which the input shockwave is arranged to be propagated to be incident upon the amplifier.

Providing multiple layers helps to superimpose components of the input shockwave that are reflected from the boundaries between the layers. This helps to amplify the intensity of the shockwave between the input and the output of the cavity.

This is considered to be novel and inventive in its own right and thus, when viewed from a further aspect the invention provides a system for producing a localised concentration of energy comprising:
an amplifier for manipulating an input shockwave, wherein the amplifier comprises:
a body comprising a first material;
   wherein the body defines a cavity for manipulating the input shockwave so to produce a manipulated shockwave;
      wherein the cavity comprises:
         an input for receiving the input shockwave incident upon the amplifier;
         an output for outputting the manipulated shockwave from the cavity; and
         a plurality of (e.g. parallel) layers between the input and the output;
         wherein the plurality of layers comprises one or more layers comprising a second material having a shock-impedance that is lower than a shock-impedance of the first material;
         wherein the system further comprises a target configured to contain fuel; and
         wherein the amplifier and the target are configured such that the manipulated shockwave is arranged to be output from the amplifier so to be incident upon the target.

It will be appreciated that this aspect may (and preferably does) include one or more (e.g. all) of the preferred and optional features disclosed herein, e.g. relating to other aspects and embodiments of the invention, as applicable. Thus, for example, preferably the layers are parallel to the input and/or output (e.g. apertures) of the cavity, e.g. perpendicular to the direction between the input and the output. Preferably the body is shaped such that a cross sectional area of the input is greater than a cross sectional area of the output.

In embodiments, the plurality of layers comprises at least one first layer and at least one second layer, wherein the at least one first layer comprises (e.g. consists of) a third material, and the at least one second layer comprises (e.g. consists of) the second material. In embodiments, the third material has a higher shock-impedance than the shock-impedance of the second material.

In embodiments, the third material is the (same material as the) first material. Thus, in these embodiments the plurality of layers comprises at least one first layer and at least one second layer, wherein the at least one first layer comprises (e.g. consists of) the first material, and the at least one second layer comprises (e.g. consists of) the second material.

In embodiments, the second material may be a solid, a liquid or a gas. In embodiments, one or more second layers may be vacuum.

In embodiments, the plurality of layers comprises a plurality of first layers and/or a plurality of second layers, wherein the plurality of layers alternate between the first layers and the second layers, e.g. (each of one or more of) the first layer(s) is adjacent (sandwiched between) two second layers and/or (each of one or more of) the second layer(s) adjacent (sandwiched between) two first layers.

In the embodiments in which the plurality of layers comprises a plurality of first layers and/or a plurality of second layers, each of the first layers may comprise (e.g. consist of) the same (e.g. third) material and/or each of the second layers may comprise (e.g. consist of) the same (e.g. second) material. However, in some embodiments, one or more of the plurality of first layers may comprise (e.g. consist of) a material that is different to the third material and/or one or more of the plurality of second layers may comprise (e.g. consist of) a material that is different to the second material.

In embodiments, one or more of the first layers and/or the second layers may be compound layers, such that the layers comprise (e.g. consist of) sub-layers. The sub-layers may be formed of different materials (e.g. materials which are different to the other sub-layers, and/or materials which are different to the second material and third material).

The plurality of layers could have any suitable and desired thickness (the dimension perpendicular to the plane in which the layers extend and are parallel). For example, each of the plurality of layers has the same thickness. In embodiments, the plurality of layers (e.g. each) have different thicknesses. In embodiments in which the plurality of layers comprises at least one first layer and at least one second layer, preferably one or more (e.g. all) of the at least one second layer (e.g. each) has a thickness that is greater than the thickness of (e.g. each of) one or more (e.g. all) of the at least one first layer.

In embodiments in which the plurality of layers comprises a plurality of first layers and/or a plurality of second layers, each of the plurality of first layers may have the same thickness and/or each of the plurality of second layers may have the same thickness, preferably with the plurality of second layers (e.g. each) having a thickness greater than the thickness of (e.g. each of) the plurality of first layers. In embodiments, the thicknesses of the plurality of first layers varies between the first layers. In embodiments, the thicknesses of the plurality of second layers varies between the second layers. In embodiments, the thicknesses of the plurality of first layers decrease (e.g. progressively) from the input to the output. In embodiments, the thicknesses of the plurality of second layers decrease (e.g. progressively) from the input to the output.

In embodiments, the second material may extend across (e.g. fill) the (width of the) cavity, i.e. in a direction perpendicular to the direction from the input to the output.

In embodiments, when the cavity contains a plurality of layers, one or more (e.g. all) of the layers extends across the (width of the) cavity (i.e. in the plane of the layer, in a direction perpendicular to the direction from the input to the output). For example, one or more (e.g. all) of the first layer(s) and/or one or more (e.g. all) of the second layer(s) may extend across the cavity.

In embodiments, the cavity comprises a gap between the second material and the body of the amplifier, i.e. between the second material and the wall(s) of the cavity. Thus the second material may be spaced from the body of the amplifier, i.e. from the wall(s) of the cavity.

In embodiments, when the cavity contains a plurality of layers, one or more (e.g. all) of the layers is spaced from the body of the amplifier, i.e. from the wall(s) of the cavity. In embodiments, the cavity comprises a gap between the plurality of layers and the body of the amplifier, i.e. between the plurality of layers and the wall(s) of the cavity. Thus, in these embodiments, all of the plurality of layers are spaced from the body of the amplifier.

When the cavity comprises a gap adjacent the wall(s) of the cavity, the gap may be filled (e.g. comprise or consist of) a vacuum. In embodiments, the gap comprises a buffer layer (e.g. comprising (e.g. consisting of) a fourth material) adjacent the walls of the cavity. Thus the (walls of the) cavity may be lined with the buffer layer. Similarly, the fourth material may be located between the second material and the body of the amplifier and/or between one or more of the plurality of layers and the body of the amplifier.

The gap and/or the buffer layer may help to reflect shockwaves from the cavity wall, reducing coupling of the shockwave into the body of the amplifier and, e.g., instead focussing the shockwave towards the output of the cavity.

Preferably the fourth material has a lower shock-impedance than that of the first material. In embodiments, the fourth material has a shock-impedance which is between that of the first material and that of the second material.

In embodiments, the gap or the buffer layer has a constant thickness (in a direction perpendicular to the wall(s) of the cavity). In embodiments, the gap or the buffer layer has a variable thickness. For example, the thickness of the buffer layer may change (e.g. increase or decrease) from the input to the output of the cavity.

The various materials discussed herein (i.e. including the first and second materials) may comprise any suitable and desired materials. In embodiments, the first material comprises (e.g. consists of) a solid. In embodiments, the first material comprises (e.g. consists of) a heavy (e.g. transition) metal, e.g. tantalum, platinum, tungsten, steel or copper.

In embodiments the second material comprises (e.g. consists of) a solid. In embodiments, the second material comprises (e.g. consists of) a polymer, e.g. a thermopolymer, e.g. polymethyl methacrylate (PMMA). In embodiments, the second material may comprise (e.g. consist of) a liquid, e.g. water, ethanol or oil. In embodiments in which the plurality of layers comprises a plurality of second layers, one or more of the plurality of second layers may comprise (e.g. consist of) a gas or a vacuum.

In embodiments, the cavity comprises a first sub-cavity and a second sub-cavity (each) arranged between the input of the cavity and the output of the cavity, wherein the first sub-cavity comprises an input and an output, and the second sub-cavity comprises an input and an output, wherein the output of the first sub-cavity is coupled to the input of the second sub-cavity. Thus the cavity may be shaped to have two (or more) sub-cavities, with the first sub-cavity arranged proximal to the input of the cavity and the second sub-cavity arranged proximal to the output of the cavity.

This is considered to be novel and inventive in its own right and thus, when viewed from a further aspect, the invention provides a system for producing a localised concentration of energy comprising:
an amplifier for manipulating an input shockwave, wherein the amplifier comprises:
   a body comprising a first material;
      wherein the body defines a cavity for manipulating the input shockwave so to produce a manipulated shockwave;
         wherein the cavity comprises: an input for receiving the input shockwave incident upon the amplifier; an output for outputting the manipulated shockwave from the cavity; a first sub-cavity and a second sub-cavity arranged between the input of the cavity and the output of the cavity; wherein the first sub-cavity comprises an input and an output, and the second sub-cavity comprises an input and an output; and wherein the output of the first sub-cavity is coupled to the input of the second sub-cavity;
wherein the system further comprises a target configured to contain fuel; and
wherein the amplifier and the target are configured such that the manipulated shockwave is arranged to be output from the amplifier so to be incident upon the target.

It will be appreciated that this aspect may (and preferably does) include one or more (e.g. all) of the preferred and optional features disclosed herein, e.g. relating to other aspects and embodiments of the invention, as applicable.

In embodiments, the body is shaped such that a cross sectional area of the output of the first sub-cavity may be different (e.g. a different size) to the cross sectional area of the input of the second sub-cavity. For example, the cross sectional area of the output of the first sub-cavity may be greater than the cross sectional area of the input of the second sub-cavity.

In preferred embodiments, however, the body is shaped such that a cross sectional area of the output of the first sub-cavity is less than a cross sectional area of the input of the second sub-cavity. Shaping the cavity in this way to provide multiple sub-cavities helps to at least partially recapture the manipulated shockwave that is output from one (e.g. the first) sub-cavity by the input of the subsequent (e.g. the second) sub-cavity. This may enable the shockwave to then be further manipulated by (e.g. focussed in) the subsequent sub-cavity. This may help to reduce the energy of the input shockwave that is lost into the body of the amplifier and thus help to increase the energy that is transmitted in the manipulated shockwave that is output from the cavity.

Preferably the input of the first sub-cavity has a cross sectional area that is greater than a cross sectional area of the output of the first sub-cavity. Preferably the input of the second sub-cavity has a cross sectional area that is greater than a cross sectional area of the output of the second sub-cavity. In this way, both of the sub-cavities have a cross sectional area that decreases from the respective input to the output, with the cross sectional area increasing from the output of the first sub-cavity to the input of the second sub-cavity.

In embodiments, the cavity comprises a plurality of sub-cavities, wherein each sub-cavity comprises an input and an output, wherein the output of each sub-cavity (apart from the output of the sub-cavity proximal to the output of the cavity) is coupled to the input of the subsequent sub-cavity (in a direction from the input to the output of the cavity), wherein the body is shaped such that a cross sectional area of the output of the each sub-cavity (apart from the output of the sub-cavity proximal to the output of the cavity) is less than a cross sectional area of the input of the subsequent sub-cavity.

Thus preferably the cavity has multiple linked sub-cavities from the input of the cavity to the output of the cavity, along the direction between the input of the cavity to the output of the cavity. Preferably the output of each (e.g. the first) sub-cavity is completely overlapping with (falls within) the input of the subsequent (e.g. the second) sub-cavity. Thus, in embodiments, the wall(s) of the cavity comprise portions that project inwards to define the (inputs and outputs of the) sub-cavities.

In embodiments, the cavity comprises a (e.g. first) layer between the first and second sub-cavities, e.g. the (e.g. first) layer extends across the output of the first sub-cavity. When there are a plurality of sub-cavities, the cavity may comprise a first layer between (e.g. each of) the adjacent sub-cavities. Separating the sub-cavities with a first layer may help to couple the shockwave between the sub-cavities.

When viewed from a further aspect, the invention provides a system for producing a localised concentration of energy comprising:
an amplifier for manipulating an input shockwave, wherein the amplifier comprises:
   an input face for receiving the input shockwave incident upon the amplifier;
   an output face for outputting the manipulated shockwave from the amplifier; and
   a plurality of (e.g. parallel) layers between the input face and the output face;
wherein the system further comprises a target configured to contain fuel; and
wherein the amplifier and the target are configured such that the manipulated shockwave is arranged to be output from the amplifier so to be incident upon the target.

It will be appreciated that this aspect may (and preferably does) include one or more (e.g. all) of the preferred and optional features disclosed herein, e.g. relating to other aspects and embodiments of the invention, as applicable. For example, one or more (e.g. all) of the preferred and optional features outlined herein relating to the plurality of layers may apply equally to this aspect of the invention.

In embodiments, any of the systems disclosed herein may comprise a mechanism for generating a shockwave to be incident upon the amplifier.

In embodiments, the mechanism for generating a shockwave comprises a mechanism configured to drive a projectile into the amplifier.

In embodiments, the mechanism for generating a shockwave comprises an explosively driven mechanism, such as a gas gun, configured to drive the projectile into the amplifier.

In embodiments, the mechanism for generating a shockwave comprises an electromagnetic mechanism, such as a pulsed power machine, configured to drive the projectile into the amplifier using electromagnetic forces. For example the mechanism may comprise a pulsed power magnetically driven plate flyer configured to drive the projectile into the amplifier.

In embodiments, the (e.g. electromagnetic) mechanism for generating a shockwave comprises an electromagnetic direct drive mechanism configured to generate a Lorentz force in an electrode adjacent the amplifier. In such embodiments, the Lorentz force generates a shockwave in the electrode which is transmitted to the input of the amplifier.

In embodiments, the mechanism for generating a shockwave comprises a laser drive mechanism. The mechanism may comprise an ablator layer adjacent the input of the amplifier cavity and one or more lasers configured to ablate the ablator layer creating a shockwave in the amplifier cavity. In embodiments, the lasers are incident directly on the ablator layer. In embodiments, the lasers are incident on a hohlraum surface, creating x-rays which bathe the ablator material causing it to ablate.

In embodiments, the target comprises a chamber configured to contain fuel.

In embodiments, the chamber is configured to contain a gaseous fuel. In such embodiments, the chamber may be gas-tight. In embodiments, the fuel may be liquid and so the chamber may (e.g. only) be configured to contain liquid fuel. In embodiments, the fuel may be solid and so the chamber may (e.g. only) be configured to contain solid fuel.

In embodiments, the target is arranged to further manipulate the manipulated shockwave output from the amplifier. In embodiments, the target may comprise a (e.g. conical) depression configured to guide the shockwave into the apex of the depression.

In embodiments the amplifier and target are abutting, e.g. at least a portion of the amplifier abuts at least a portion of the target (e.g. at least a portion of the output face of the amplifier abuts at least a portion of the target).

In embodiments, the amplifier and target are physically spaced apart, i.e. there is a spacing between the amplifier and the target, so that the amplifier and target are not in (e.g. direct) contact with each other.

In embodiments, the system comprises a mount configured to hold the amplifier and target in place relative to one another. In embodiments, the mount comprises a clamp.

When viewed from a further aspect, the invention provides a method of producing a localised concentration of energy using a system according to any one of the aspects or embodiments described herein, the method comprising:
generating a shockwave to be incident upon the amplifier;
manipulating the shockwave with the amplifier; and
causing the manipulated shockwave to be incident upon the target.

It will be appreciated that this aspect may (and preferably does) include one or more (e.g. all) of the preferred and optional features disclosed herein, e.g. relating to other aspects and embodiments of the invention, as applicable.

It will be understood that where used herein, the term “shock-impedance” is intended to mean “the pressure which must be applied to a medium in order to impart a unit particle velocity to some of the medium” (Henderson, ‘On the refraction of shock waves’, Journal of Fluid Mechanics, Volume 198, January 1989, pages 365-386). This is equal to the product of the shock speed and the density of the un-shocked material.

It will be understood that the input shockwave may be formed outside of the cavity, and propagate into the input of the cavity, but may additionally or alternatively be generated in the amplifier, for example by the amplifier being struck (e.g. by a projectile). Both alternatives are covered by the wording “input shockwave”.

Embodiments of the system may be suitable for manipulating (e.g. amplifying) shockwaves to generate localised energy concentrations, for the purpose of generating conditions suitable for nuclear fusion in the target. Thus, the target may (e.g. be configured to) contain fusionable fuel, such as hydrogen, deuterium and/or tritium in liquid, solid and/or gaseous form. However, the system is not limited to this, and may be used for other applications in which the target contains a (e.g. different type of) fuel.

### BRIEF DESCRIPTION OF DRAWINGS

Certain embodiments of the invention will now be described, by way of example only, with reference to the accompanying drawings, in which:

FIG. 1 shows a schematic diagram of an apparatus in accordance with an embodiment of the invention;

FIGS. 2a, 2b, 2c and 2d show four successive stages of an interaction of a shockwave with an apparatus in accordance with another embodiment of the invention;

FIG. 3 shows a vertical cross section through an exemplary amplifier;

FIGS. 4a, 4b, 4c, 4d, 4e and 4f show six successive stages of an interaction of a shockwave with the amplifier of FIG. 3.

FIG. 5 shows a vertical cross section through a target;

FIG. 6 shows a variant of the target of FIG. 5;

FIG. 7 shows a variant of the target of FIG. 5;

FIG. 8 shows a variant of the target of FIG. 5;

FIG. 9 shows a variant of the target of FIG. 5;

FIG. 10 shows a variant of the target of FIG. 5;

FIG. 11 shows a vertical cross section through an alternative target;

FIG. 12 shows a variant of the target of FIG. 11;

FIG. 13 shows a vertical cross section through another exemplary amplifier.

### DETAILED DESCRIPTION

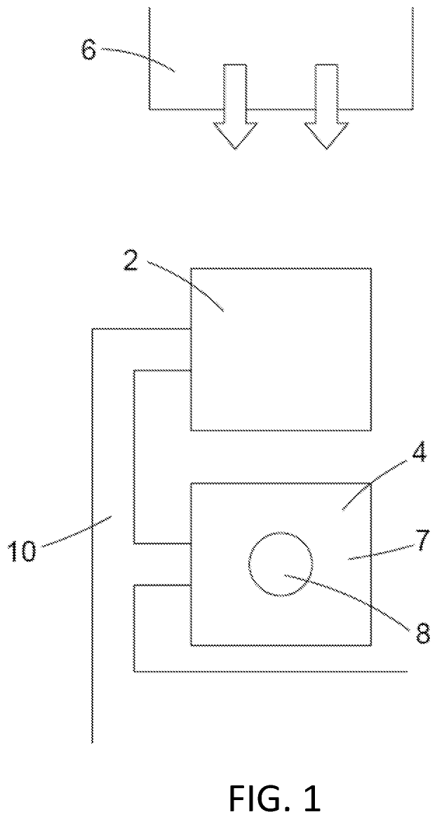

FIG. 1 shows schematically an arrangement in accordance with an embodiment of the invention. An amplifier 2 and target 4 are provided. The target 4 is constructed from a solid medium 7 and defines a pocket 8 which is configured to contain fusionable fuel, such as liquid deuterium, solid deuterium or deuterium gas.

FIG. 1 shows a substantially planar projectile 6. In the Illustrated embodiment, the projectile 6 is a flat disk, but other projectiles may be used. The apparatus also includes a mount 10 which supports both the amplifier 2 and the target 4. The mount 10 is arranged to support the amplifier 2 and target 4 such that the amplifier 2 is provided between the projectile 6 and the target 4. In this way, the projectile 6 strikes the amplifier 4.

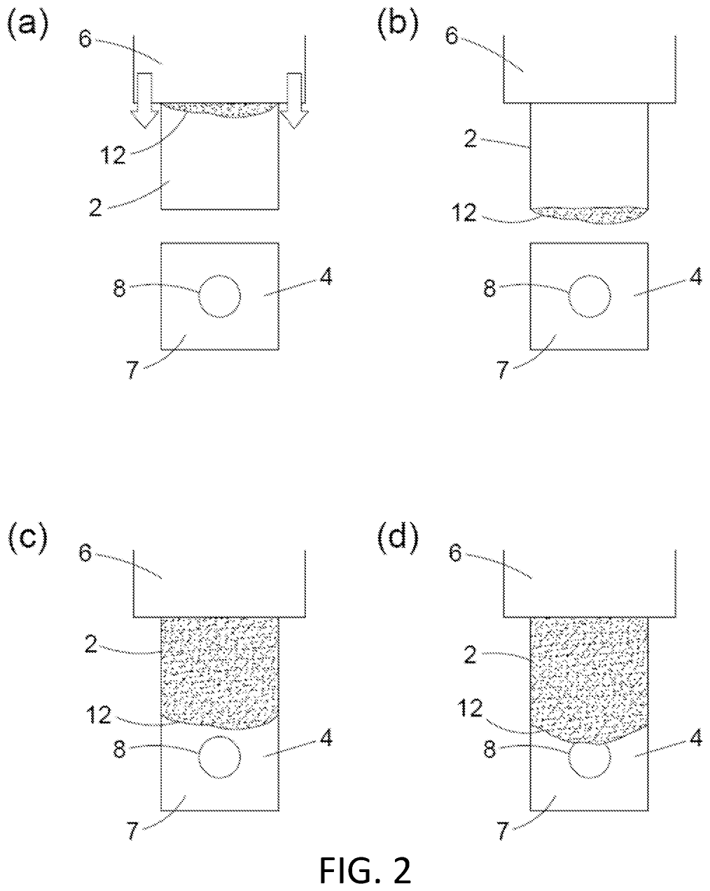

The operation of this embodiment will now be described, with particular reference to the four successive stages shown in FIGS. 2a-2d.

Initially, the projectile 6 strikes the amplifier 2. The projectile 6 may be propelled by (for example) a light gas gun or a pulse power machine magnetically driven plate flyer. As the projectile 6 strikes the amplifier 2, a planar shockwave 12 is generated in the amplifier 2, as seen in FIG. 2a. As the shockwave 12 propagates through the amplifier 2, the speed, pressure and shape of the shockwave 12 is manipulated by the internal design of the amplifier 2, as seen in FIG. 2b.

At FIG. 2c, the shockwave 12 emerges from the amplifier 2 and is incident upon the target 4. As the shockwave 12 propagates through the target 4, it becomes incident upon the target pocket of fuel 8, as shown in FIG. 2d. This compresses the fuel inside the target pocket of fuel 8, causing intense local heating, which may be sufficient to initiate fusion.

By providing an amplifier 2 between the projectile 6 and the target 4, the shockwave 12 is modified and channelled by the amplifier 2 such that the shockwave pressure pulse that is emitted from the amplifier 2 has a pressure profile, velocity and duration which is enhanced. Further, by providing the amplifier 2 and target 4 separately, a “plug and play” system is achieved, where different amplifier designs can be used with different target designs to achieve specific shock conditions. Further, for the purposes of experimentation, alternative targets/amplifiers can be trialled without needing to reconfigure the entire system.

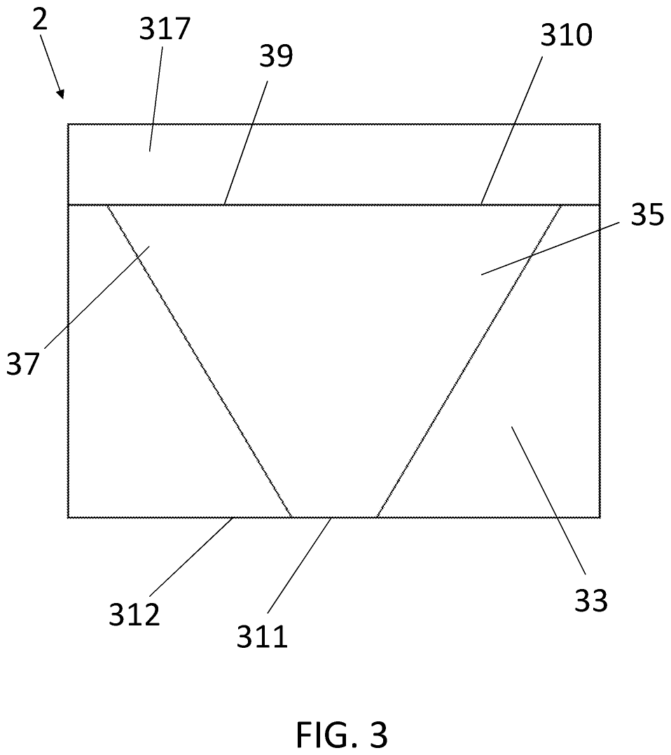

FIG. 3 shows a vertical cross section through an amplifier 2. It will be understood that the amplifier 2 shown in FIG. 3 is purely exemplary and that other amplifier designs may be used in accordance with embodiments of the present invention.

The amplifier 2 comprises a body 33 which defines a hollow frustum shaped cavity 35. The body 33 is formed of a material having a high shock-impedance. In the illustrated embodiment, the body 33 is formed of a high shock-impedance material such as tantalum, platinum, tungsten, steel, copper, or other (e.g. heavy) metals. The cavity 35 contains a material 37 having a low shock-Impedance. The cavity fill material 37 has a lower shock-impedance than that of the body 33. In the illustrated embodiment, the cavity fill material 37 is polymethyl methacrylate (PMMA), however other materials are envisaged, and the cavity fill material 37 may be a solid, liquid or gas.

The cavity 35 has an input 39 which is configured to receive a shockwave and an output 311 which is configured to output the shockwave after the shockwave has propagated through the amplifier 32. The cross sectional area of the input 39 is greater than that of the output 311.

FIG. 3 shows a vertical cross section and, in the illustrated embodiment, the amplifier 2 is rotationally symmetrical. It will therefore be understood that the cavity 35 of the amplifier 2 is shaped as a conic frustum with an input radius greater than the output radius. The amplifier 2 has an input face 310 which is proximal to the input 39 of the cavity 35 and an output face 312 which is proximal to the output 311 of the cavity 35.

FIG. 3 shows an embodiment of the amplifier 2 having an impedance matching layer 317 provided on the input face 310 of the amplifier 2. The impedance matching layer 317 is a planar layer of material having a shock-impedance which is between that of the projectile 6 and that of the cavity fill material 37. The impedance matching layer 317 improves the coupling efficiency into the amplifier 2 such that a higher proportion of the energy input into the amplifier 2 by the projectile 6 is transmitted into the cavity fill material 37.

In embodiments, the impedance matching layer 317 may be formed of a material having a variable shock-impedance, such as a high impedance foam. The first shock will encounter a relatively low impedance material, but will compress the foam such that aftershocks then encounter a compressed, and hence high-impedance, material. Such an impedance matching layer 317 may allow a low-impedance projectile 6 to be used since the low-impedance projectile may effectively couple to the foam.

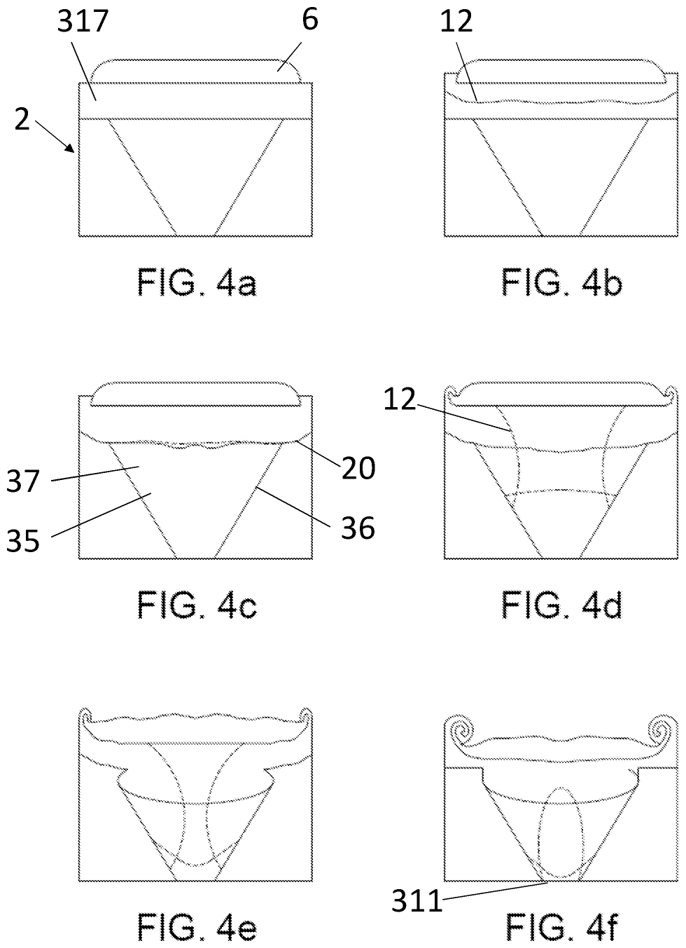

The function of the amplifier 2 will now be further explained with reference to FIGS. 4a-e. FIGS. 4a-e show a projectile 6 striking the amplifier 2 shown in FIG. 4a. FIG. 4a shows the projectile 6 striking the impedance matching layer 317. At FIGS. 4b and 4c, a resulting shockwave 12 passes through the impedance matching layer 317 and enters the cavity fill material 37. Pressures are increased in the amplifier 2 through shockwave reflection and superposition within the cavity 35.

On input into the cavity 35, the input shock reflects from the cavity walls 36, as seen in FIG. 4d, as an irregular shock reflection (Mach reflection), that propagates in from the cavity walls 36, eventually overlapping on the central axis of the cavity 35 as shown in FIG. 4e and FIG. 4f.

The overlap of this radially-symmetric wave on the central axis creates a high pressure point within the cavity fill material 37, which expands and interacts with the impinging Mach reflection, leading to the generation of an axial, quasi-planar Mach stem that propagates towards the output 311 of the cavity 35. This wave eventually reaches the output 311 of the cavity 35 and emerges from the amplifier 2 with a higher pressure than that of the original input shockwave 12.

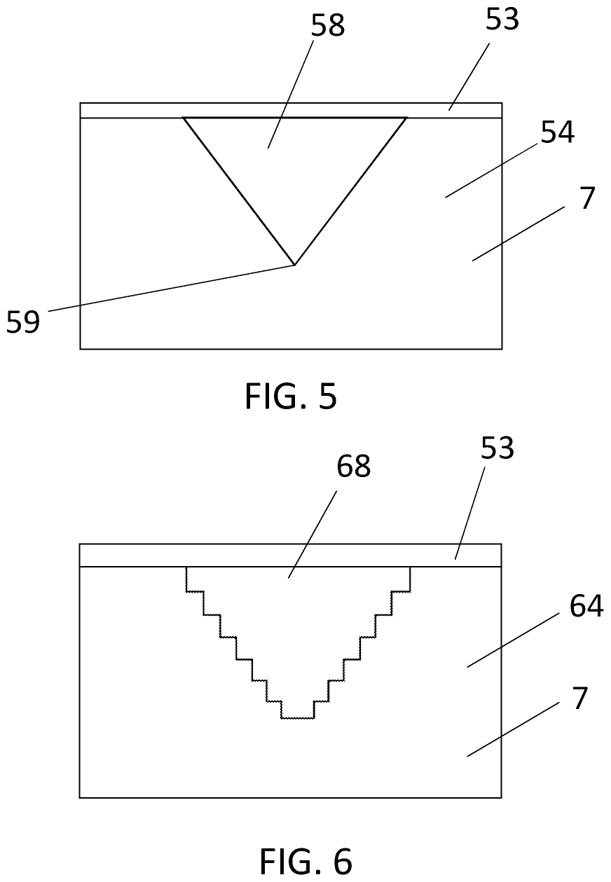

In FIG. 1, the target 4 defines an internal chamber 8 which is configured to contain fusionable fuel. In other embodiments, the chamber 8 may be formed as an indent in a surface of the target 4. In such embodiments, the surface of the target may be covered by a coverslip in order to contain the fuel. Alternatively, where the target is abutting the amplifier, a coverslip may not be necessary to contain the fuel. FIG. 5 shows a vertical cross section through a target 54 defining a conical chamber 58. In the illustrated embodiments, the target is formed of gold although other materials, such as platinum, tungsten, steel, or aluminium are also considered.

In use, the chamber 58 contains fusionable fuel, such as liquid deuterium, solid deuterium or deuterium gas. The chamber 58 is sealed by a coverslip 53 which is placed on the surface of the target. As the manipulated shockwave propagates into the chamber 58, the gas is compressed by the shockwave and forced into the point 59 of the chamber 58.

FIG. 6 shows a variant of the target shown in FIG. 5. The target 64 defines a chamber 68 which is shaped as a saw-tooth cone, such that the wall of the chamber 68 is stepped. The saw-tooth shape may help the shockwave to trap and therefore compress gaseous fuel.

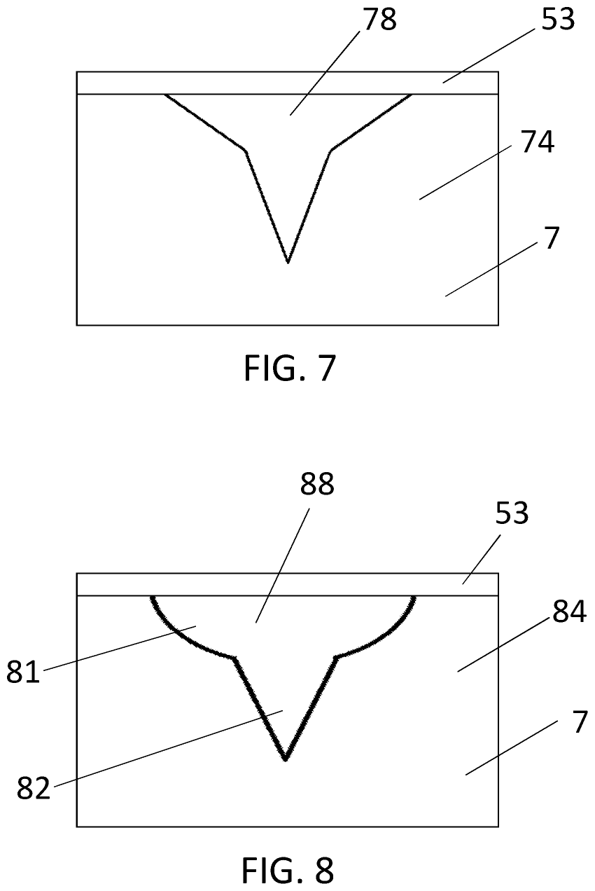

FIG. 7 shows a variant of the target shown in FIG. 5. The target 74 defines a biconic chamber 78. The chamber 78 is shaped as a cone, wherein the chamber wall comprises two sections which are at different angles to the longitudinal axis of the chamber. In embodiments, more than two wall sections may be provided, for example, the chamber may be triconic. In embodiments, the chamber wall may be curved such that the chamber has the shape of a flared cone. Such targets may facilitate greater compression of the gaseous fuel since the shape of the chamber further focusses the shockwave after exit from the amplifier 2.

FIG. 8 shows a variant of the target shown in FIG. 5. The chamber 88 comprises two sections. The first section 81 is proximal to the output of the amplifier 2 and is bowl shaped. The second section 82 is conic. The first and second sections both share the same central axis. The chamber 88 helps to prevent jetting and creates a convergent shock above the second section 82, compressing the gaseous fuel into the second section 82.

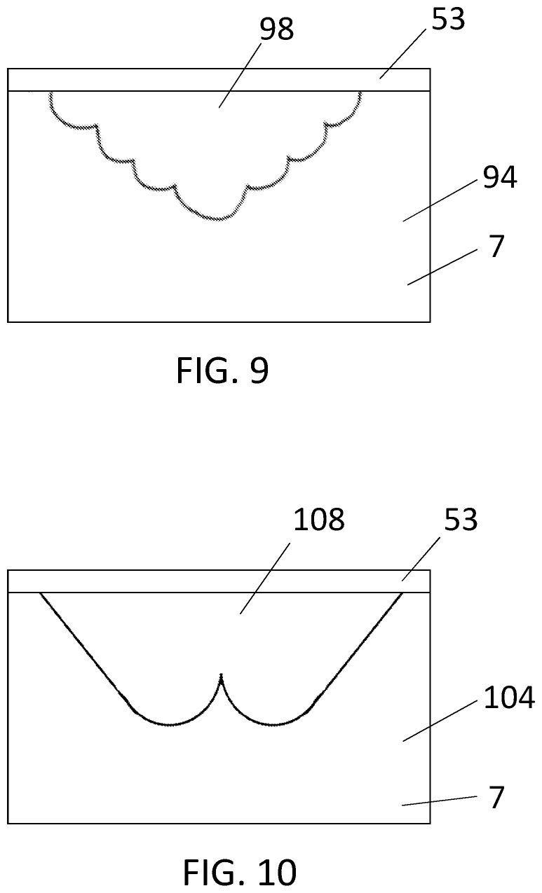

FIG. 9 shows a variant of the target shown in FIG. 5. The chamber 98 of the target 94 has a tiered curved chamber wall. The chamber 98 helps to prevent jetting and creates a series of convergent shocks. Further, the curved surfaces slow jetting of the coverslip 53.

FIG. 10 shows a variant of the target shown in FIG. 5. The chamber 108 of the target 104 is shaped as a cone, with walls which, proximal to the tip of the cone, gradually transition back towards the base of the cone, with the tip of the inverted cone aligned with the central axis of the chamber 108. As can be seen in FIG. 10, a vertical cross section taken through the chamber 108 forms an approximate curved “W” shape. The inverted cone portion of the chamber wall channels the shockwave into a converging central section, giving higher dimensional convergence.

In all respects, other than those explicitly mentioned, the construction of the variant targets 64, 74, 84, 94, 104 described above is as described in relation to target 54.

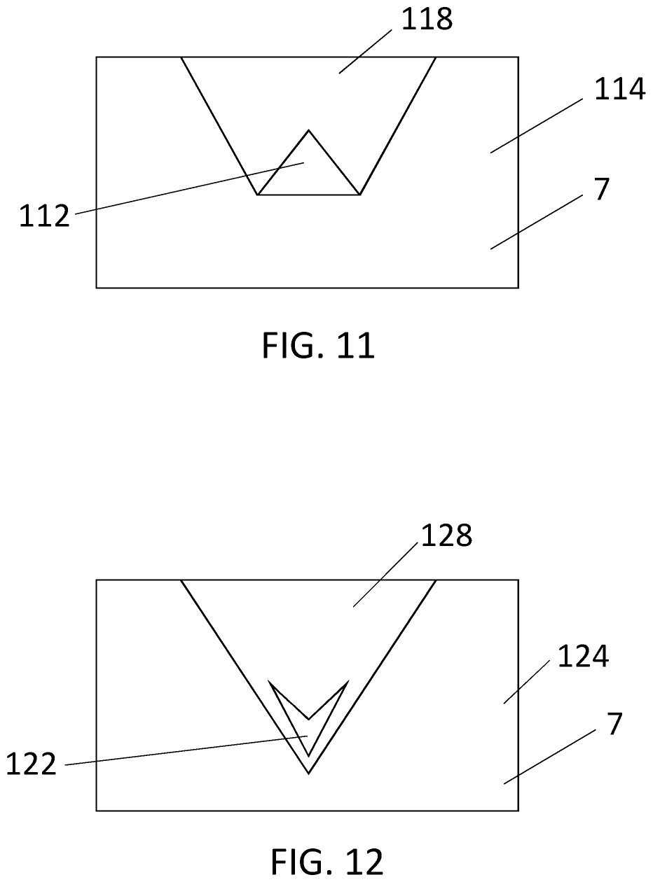

FIG. 11 shows an alternative target design. FIG. 11 shows a vertical cross section through a target 114 defining a frustoconical chamber 118. The target 114 is formed of a high impedance material 7 which in the illustrated embodiment is tantalum. The chamber 118 is filled with a material having a lower impedance than the target material. In the illustrated embodiment, the chamber fill material is polymethyl methacrylate (PMMA). The chamber fill material defines an inverted conical sub-chamber 112 located at the narrow end of the chamber 118. In use, the sub-chamber 112 contains fusionable fuel, such as liquid deuterium, solid deuterium or deuterium gas. As the manipulated shockwave propagates through the chamber fill material and into the sub-chamber 112, the fuel is compressed by the shockwave.

FIG. 12 shows a variant of the target of FIG. 11. In the target 124, the chamber 128 is conical and the sub-chamber 122 has an arrowhead cross section, such that the sub-chamber 122 is shaped as a cone, with a conic depression in its base. The point of the cone of the sub-chamber 128 is proximal to the tip of the cone of the chamber 128. In use, shocks may drive in the points at the base of the arrowhead (the perimeter of the base of the cone, when considered in three dimensions), pre-heating and pre-compressing the fuel prior to the shocks converging at the tip of the sub-chamber 122 and impacting the pre-heated and partially collapsed fuel.

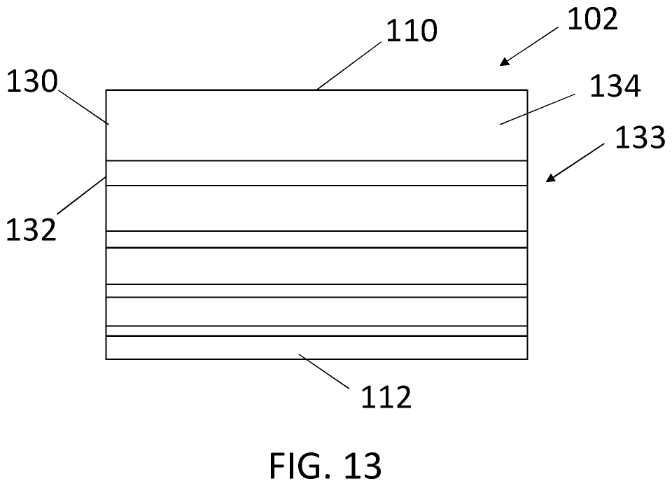

FIG. 13 shows an amplifier 102 according to another embodiment of the invention. The amplifier 102 comprises a body 133 formed of a series of parallel layers. The layers comprise low shock-Impedance layers 130 formed of a low shock-impedance material such as PMMA or epoxy resin and high shock-impedance layers 132 formed of a high shock-impedance material such as tantalum, tungsten, steel, copper, or platinum. As a minimum requirement, the high shock-impedance layers 132 are formed of a material having a higher shock-impedance than the material forming the low shock-impedance layers.

The parallel layers alternate from low shock-impedance layers 130 to high shock-impedance layers 132 from one layer to the next. In the illustrated embodiment, an input layer 134 which forms the input face 110 of the amplifier 102 is a low shock-impedance layer 130. This is because an input face 110 formed from a high shock-Impedance layer 132 would result in a larger portion of the shockwave being reflected by the input face 110 and hence not transmitted into the amplifier 102. However, the alternative is also envisaged.

In the illustrated embodiment, the thicknesses of the high shock-impedance layers 132 and the low shock-impedance layers 130 decrease progressively from the input face 110 to the output face. In embodiments however, the high shock-impedance layers 132 are each of equal thickness. It will be understood that although the thickness may vary between layers, each individual layer has a uniform thickness across its width.

The layers are arranged such that shockwaves generated at the input face 110 of the amplifier 102 of the layer stack reverberate within the stack of layers, as a result of reflections from the high shock-impedance layers 132, leading to regions of constructive and destructive interference as shock waves pass over one another. When a shock passes from a low shock-impedance layer 130 into a high shock-impedance layer 132, a portion of the shock is transmitted into the high shock-impedance layer 132 whilst a portion is reflected back into the low shock-impedance layer 130.

The portion in the low shock-impedance layer 130 speeds up since it is now travelling through pre-shocked material, the shock portion then reflects from the boundary at the input of the low shock-impedance layer, and since it has been sped up, the reflected portion eventually catches up with the portion of the shock that was initially transmitted into the high shock-impedance layer 132. Through the arrangement of the low and high shock-impedance layers 130, 132, the amplifier 102 can be arranged such that a plurality of shock features superimpose on the output face 112 of the amplifier 102, leading to a short-lived high shock pressure state that can be passed into a target adjacent to the amplifier output 112.

In the illustrated embodiment, all of the high shock-impedance layers 132 are formed from the same material and all of the low shock-impedance layers 130 are formed from the same material. In embodiments, different low shock-impedance materials may be used for the different low shock-impedance layers 130 and different high shock-impedance materials may be used for the different high shock-impedance layers 132.

In each of the embodiments described above, the diagrams shown are a vertical cross section through a three-dimensional volume of gas and target surface and hence they depict embodiments that are rotationally symmetric. However, this is not essential to the invention.

1. A system for producing a localised concentration of energy comprising:
an amplifier arranged to manipulate one or more of the speed, pressure or shape of an input shockwave, wherein the amplifier comprises:
a body comprising a first material;
wherein the body defines a cavity for manipulating the input shockwave so to produce a manipulated shockwave;
wherein the cavity comprises: an input for receiving the input shockwave incident upon the amplifier; and an output for outputting a manipulated shockwave
wherein the system further comprises a target configured to contain fuel; and
wherein the amplifier and the target are configured such that the manipulated shockwave is arranged to be output from the amplifier so to be incident upon the target.

2. The system as claimed in claim 1, wherein the cavity contains a second material having a shock-impedance that is lower than a shock-impedance of the first material.

3. The system as claimed in claim 1, wherein a cross sectional area of the input is greater than a cross sectional area of the output.

4. The system as claimed in claim 1, wherein the cavity is frustum shaped.

5. The system as claimed in claim 1, wherein the cavity comprises a conic frustum

6. The system as claimed in claim 1, comprising a mechanism for generating a shockwave to be incident upon the amplifier.

7. The system as claimed in claim 6, wherein the mechanism for generating a shockwave comprises a mechanism arranged to drive a projectile into the amplifier.

8. The system as claimed in claim 6, wherein the mechanism comprises an electromagnetic mechanism.

9. The system as claimed in claim 6, wherein the mechanism comprises an explosively driven mechanism.

10. The system as claimed in claim 6 wherein the mechanism comprises an electromagnetic direct drive mechanism configured to generate a Lorentz force in an electrode adjacent the amplifier.

11. The system as claimed in claim 6, wherein the mechanism for generating a shockwave comprises a laser drive mechanism comprising an ablator layer adjacent the input of the amplifier cavity component and one or more lasers configured to ablate the ablator layer.

12. The system as claimed in claim 1, wherein the target comprises a chamber configured to contain fuel.

13. The system as claimed in claim 12, wherein the chamber is configured to contain a gaseous fuel.

14. The system as claimed in claim 1, wherein the target is arranged to further manipulate the manipulated shockwave output from the amplifier.

15. The system as claimed in claim 1, wherein the amplifier and the target are abutting,

16. The system as claimed in claim 1, wherein the amplifier and the target are physically spaced apart.

17. The system as claimed in claim 1, further comprising a mount configured to hold the amplifier and the target in place relative to one another.

18. (canceled)

19. A system for producing a localised concentration of energy comprising:
an amplifier for manipulating an input shockwave, wherein the amplifier comprises:
a body comprising a first material;
wherein the body defines a cavity for manipulating the input shockwave so to produce a manipulated shockwave;
wherein the cavity comprises;
an input for receiving the input shockwave incident upon the amplifier;
an output for outputting the manipulated shockwave from the cavity; and
a plurality of layers between the input and the output;
wherein the plurality of layers comprises one or more layers comprising a second material having a shock-impedance that is lower than a shock-impedance of the first material;
wherein the system further comprises a target configured to contain fuel; and
wherein the amplifier and the target are configured such that the manipulated shockwave is arranged to be output from the amplifier so to be incident upon the target.

20. (canceled)

21. A system for producing a localised concentration of energy comprising:
an amplifier for manipulating an input shockwave, wherein the amplifier comprises:
an input face for receiving the input shockwave incident upon the amplifier;
an output face for outputting the manipulated shockwave from the amplifier; and
a plurality of layers between the input face and the output face;
wherein the system further comprises a target configured to contain fuel; and
wherein the amplifier and the target are configured such that the manipulated shockwave is arranged to be output from the amplifier so to be incident upon the target.

22. A method of producing a localised concentration of energy using a system as claimed in claim 1, wherein the method comprises:
generating a shockwave to be incident upon the amplifier;
manipulating the shockwave with the amplifier; and
causing the manipulated shockwave to be incident upon the target.
